(19) United States
(12) Patent Application Publication
(10) Pub. No.: US 2007/0269785 A1
(43) Pub. Date: Nov. 22, 2007

(54) System for Guiding or Teaching a Working Procedure

(76) Inventor: Yoshiaki Yamanoi, Tokyo (JP)

Correspondence Address: ABELMAN, FRAYNE & SCHWAB, 666 THIRD AVENUE, 10TH FLOOR, NEW YORK, NY, 10017, US

(21) Appl. No.: 11/660,194

(22) PCT Filed: Aug. 11, 2005
(86) PCT No.: PCT/JP05/15032

§ 371 Date: Feb. 12, 2007

(30) Foreign Application Priority Data
Aug. 12, 2004 (JP) 2004-235410

(51) Int. Cl. G09B 5/00

(52) U.S. Cl. 434/308

(57) ABSTRACT

A working procedure as it is, is guided and taught, and as the use is continued the working procedure is guided and taught in such a manner that the mastery and working speed of the utilizer may be automatically fitted while the level of the worker is controlled so as to be always fitted. The system comprises means in which the working procedure is stored as images and displayed by continuous images; audio data storage means consisting of audio data in which the working procedure of a first level is recorded in association with said series of the workings and audio data of a second level of less audio information recorded in said first level, being constituted by optional levels; audio data selection means which selects the working procedural information to be outputted from among the plural working procedural information pieces based on said working speed; and means in which the selected audio data and the images are outputted being associated.

### FIELD OF THE INVENTION

This invention relates to a system for guiding or teaching a working procedure established in advance with regard to various kinds of workings. More particularly this invention relates to a system in which the mastery and working speed of a worker can be improved and the mastery level can be automatically evaluated. Further, this invention relates to a system in which it is discriminated to what extent the worker's working speed is in comparison to a standard working speed, and it is judged whether the discriminated level is reasonable or not thereby to enable even a rating training to be carried out.

### BACKGROUND OF THE INVENTION

As the background technique there can be mentioned a method and a system disclosed in Japanese Patent Kokai No. 2001-14016 filed in the name of the inventor of this application. Said technique discloses the following matters:
Analysis of motion elements of working steps;
Possible optional establishment of working speed level (rating) for the respective motion elements analyzed;
Possible regeneration of the respective motion elements in response to an optional working speed level;
Possible recording of the motion content, with characters, for every analyzed motion elements;
Possible deletion of unnecessary motion element in response to the analyzed motion element; and
Possible deletion of unnecessary motion elements and possible simulation by image in a state where the display magnification has been set for each of the motion elements.

That is, the earlier application describes a system and a method which enables the fundamental motions to be performed as an analysis system. Said technique has made it possible to freely carried out analysis and retaining of motion elements as well as processing, etc. of the data, and to carry out speedily a more detailed establishment of the factors regarding the motion elements.

### DISCLOSURE OF THE INVENTION

### Problems to be Solved by the Invention

In the earlier invention, the motion elements of working steps are analyzed and recorded with images, and therefore it is possible to guide and teach the worker through the comparison and review of the list describing the worker's working pictures and analytical contents based on the recorded data, but there was not created a concept that a working procedure is guided or taught to the worker and the working speed of the worker is improved in respect of various working contents.

As alternative known technique there is carried out since long before a method for guiding and teaching the working procedure by using images such as of VTR or VCR, in which method information data of images according to the levels for advanced workers and beginners are prepared in advance, and by suitably selecting the information data according to the worker's level the worker's skill could be improved. Further, it has also been carried out since long before that tests are periodically performed to the workers, and the level is established for each worker based on the tests whereby the worker's level is planned to be improved.

However, irrespective of the skill level so far possessed by the worker, it is required to start guiding and teaching from zero or low level relative to quite a new working whatever skill level is improved for the worker whereby it cannot be said that the worker who has established a high skill level can necessarily make a speedy skill improvement. Furthermore, even if the worker is the same his/her working speed may greatly fluctuate depending on his/her physical conditions according to the working day. In respect of human working a great fluctuation of the working speed would not be avoidable. Moreover, even in the manufacturing spot where workings are repeated many time by nature, because of the tendency of production of many kinds and small amount of products in these days, it is necessary to achieve the working without making a mistake with new readiness of mind relative to new working without being influenced by the working achieved just before. However, in the casing of proceeding with the working by relying on memory or perception, a mistake is likely to occur particularly in case the working procedures are similar. Even if there were gathered workers who have approximately the same skill level the working will not flow necessarily smoothly because of the complicated problems as described above.

Therefore a system for guiding and teaching a working procedure with higher flowability or response ability is earnestly desired. That is, at the new start an image or an audio signal which guide and teach at, for example, about 70% level relative to the standard level while adding a sufficient explanation, the comprehension or mastery of the worker is detected or the instruction for the flowing level-up is outputted in accordance with the self-report, and in case the finishing conditions have deteriorated an instruction of returning the level to the preceding one it is earnestly desired that the establishing operation of such guiding and teaching levels is performed wholly or partly.

### Means for Solving the Problems

In order to solve the above problems the system for guiding and teaching a working procedure defined in claim 1 comprises:

display means in which the working procedure of a series of working is stored as images of the working procedure, and the procedural images of the working are continuously displayed;

storage means of storing audio data which are associated with said working procedure of the series of workings and in which the guide information of the working procedure of at least a first level is recorded, and audio data of the guide information of the working procedure of a second level in which audio information less than the audio information is recorded in said first level;

detection means for detecting the working speed of a series of workings;

audio data selection means in which based on the working speed detected by said detection means the working procedure information to be outputted from among the plural working procedure information pieces stored in said storage means is selected; and

output means in which the audio data selected by said audio data selection means and the images displayed on said display means are outputted being associated.

Then, to realize the above subject, the system for guiding and teaching the working procedure defined in claim 2 is characterized in that the images of the working procedure in claim 1 are analyzed for each motion element, a rating is set relative to the working speed for said each motion element, and said rating is varied in response to said working speed whereby the difference between the working speed and the image of the working procedure is made adjustable.

Further, in the system for guiding and teaching the working procedure defined in claim 3, a pair of audio data and image data are prepared for each level described in claim 1.

Furthermore, to realize the above subject, the system for guiding and teaching the working procedure defined in claim 4 is characterized in that the images of the working procedure in claim 1 are discriminated and displayed in part of the display means by the color or light quantity previously set for each level.

Moreover, in the system for guiding and teaching the working procedure defined in claim 5, in that the level of the present working speed is displayed by the detection means for detecting the working speed in claim 1, a rating can be established relative to the working speed corresponding to another level, and the image processed by the rating corresponding to said another level can be referenced to.

Still, in the system for guiding and teaching the working procedure defined in claim 6, the detection result of said working speed or the level fluctuation of the level in claim 1 is continuously recorded as computer data.

Still more, in the system for guiding and teaching the working procedure defined in claim 7, in case the present level obtained by the detection means for detecting the working speed in claim 1 exceeds the previously set threshold even if it does not reach a level higher than the present level, a working procedure guidance for a level higher than the present level can be outputted.

### EFFECT OF THE INVENTION

The system for guiding and teaching the working procedure defined in claim 1 is constituted such that the level of the audio data of the guidance information may vary according to the working speed of the worker. For example, for the worker as beginner audio data of guidance information of a first level to be minute guidance information are selected, and as the worker is accustomed for the working and the working speed is accelerated, the guidance information of a second level is automatically selected. Compared with the guidance information of the first level the guide information of the second level is suitable for the working whose quantity (number of words) of audio information is less and which is quick.

Further, according to the system for guiding and teaching the working procedure defined in claim 2, if the working speed of the worker becomes, for example, faster, only the speed associated with the motion elements relied on the working speed of the worker without changing the working speed relied on the machine fixed in response thereto, becomes to change. Thus, by adjusting the speed a high followability or response ability is obtained relative to the working speed of the worker.

Moreover, according to the system for guiding and teaching the working procedure defined in claim 3, it is possible to simultaneously record, as ordinary video data, the audio data and the image data. Although the photographing and sound recording for each level requires a lot of time, the recording can be easily carried out relied only on the know-how same as the classic video photographing.

According to the system for guiding and teaching the working procedure defined in claim 4, it becomes clear not only to the worker but also to a third party based on which level speed the worker is working at present. Further, if the workers are sorted by color for each group and the skill level of each worker is expressed by the intensity of the light quantity, the level of each worker becomes clear to the controller, and in addition even the sum of the lights for respective groups can be judged intuitively or by measurement.

Furthermore, in the system for guiding and reaching the working procedure defined in claim 5, it is capable of simulating an image in the condition where an optional worker has leveled up (or down). Accordingly, in case the worker has leveled up to a higher level it is possible to falsely experiment, as an image in advance, how speedily the working should be done. In addition, by said simulation it is possible to judge whether the working can be possible for an optional worker or not. Moreover, sometimes there appears a case of producing a simulation result that any worker cannot do the working because of too high speed, and in that case it is seen that the level establishment itself is improper and that the level establishment in the controlling side of said system is erroneous. That is, the present system is even for training the level establishment of the controlling side not limited to the worker. In addition, by the speed in which working is impossible to any worker because of too high speed is meant a state where the working speed is over 171% to 190% or 200% in the case of 100% of the standard working speed.

Further, in the system for guiding and teaching the working procedure defined in claim 6, since the process of the level fluctuation for each worker is continuously recorded the working result can be controlled for each of workers. Naturally, in addition to the control of the working result, the group data, the controller's data, the error data, etc. are registered in parallel to allow more detailed data to be built up.

In the system for guiding and teaching the working procedure defined in claim 7, before the mastery of the worker reaches a higher level it becomes possible to try whether working can be done or not with said higher level speed. Therefore, being caused by too much guide information in the present level there occurs a case where so far as the working is done by listening one by one to said too much information it is capable of reaching the working speed higher than the present level, and in that case it becomes possible to avoid the trouble of level improvement.

### BEST MODE FOR CARRYING OUT THE INVENTION

The invention will now be described more in detail, by way of an Example, with reference to the accompanying drawings.

FIG. 1 and FIG. 2 are perspective views showing the operative state of the system according to the invention. In the drawings, the reference letter “A” designates a display to be display means, “B” storage means for image data, “C” storage means for guide information, “E” a worker, and “F” light indication means respectively.

The working procedure predicted by the worker “E” is recorded as video image data, and the data thus recorded are stored in the storage means “B”. The five kinds of the image data described below in detail are memorized in the storage means “B” for the data image.

The first image data B01 are recorded information of recording digital image including detailed explanatory information B01A for the worker (beginner) who engages for the first time in the procedural information of the working and in said working, and after the recording the information is compiled so as to be recorded as a digital image suited for use.

The second image data B02 are the recorded information in which the explanatory information B01A is drawn off from the image data B01.

The third image data B03 are the recorded information in which are recorded the digital image including the procedural information of the working and the detailed explanatory information for the worker who engages for the first time in said working. The third image data B03 are different from the image data B01 in that the digital recording is made in one package state (state of one image data continued on a time axis) which is utilized without compilation.

The fourth image data B04 are the image data recorded for the workers who work at standard working speed, and said image data record the procedural information of basic working but not including commentary information for beginners. Further, said image data are digitally recorded in a one package state that is utilized without compilation.

The fifth image data B05 are the recorded information recorded for the workers who perform the working at a 140% working speed in the case where the standard working speed is 100%. The recording contents are recorded comparatively less with regard to the working procedure, the wording that promotes the checkpoint for producing a more accurate product is recorded, and the information not limited to faster speed but improving the product level is recorded.

As described above, in the embodiment the five kinds of image data each being characterized are prepared. Further, there are respectively prepared audio data in which the guidance information of the working procedure is recorded in response to the respective image data, and auxiliary indication signal.

The first image data B01 are, as described above, the image data including an explanatory image for beginners. Then, the working speed is set to be maximally retarded. Further, the guidance information by the sound responding to the image data and said auxiliary indication signal can be simultaneously recorded when the image data B01 are recorded, and while observing the image data B01 the inputting working can be carried out by after recording. The guiding information C01 shown in FIG. 1 is audio data prepared by said after-recording and an auxiliary indication signal.

The second image data B02 are image data in which the explanatory image for the beginners is deleted by compilation. Moreover, the rating value is set so that the speed of the motion may be varied, for each motion element by dividing the image data of the working procedure. Then, by adjusting the rating value the rating is adjusted in such a way that the image for beginners may become a speed considered to be a standard speed by the discretion of the controller side whereby the speed of the image can be adjusted. The guiding information C02 by sound relative to the second image data B02 thus prepared is newly recorded by the after-recording. In addition, by faithfully compiling about time axis the first image data and the audio data it is possible to delete the explanatory sound for beginners and to obtain an image and a sound close to the standard working speed.

The third image data B03 are, as described above, recorded information in which the digital images are recorded, said information including the working procedural information and the explanatory information for the worker who engages for the first time in said working. The third image data B03 is different from the image data B01 in that the data B03 digitally record the data in a utilizable condition without compilation. The audio information C03 responding to said image is such one where, for example, the sound recorded at the same time when the image data are prepared, is utilized. In addition, referring to the sound it is possible to utilize the audio data re-put by the after-recording, and as a common point said audio information is recorded by one package without prearrangement of changing the speed. Therefore, there is no prearrangement of changing the speed, so that even consideration is not needed for such case where the clearness decreases by the change of the speed.

The fourth image data B04 are those which do not build the data for compilation similarly to B03, and they are recorded information which are recorded for the workers who work the working at a speed considered to be said standard working speed.

The guidance information C04 associated with said comparatively faster working speed is audio data recorded by after-recording, the sound is recorded in consideration that the audio guidance does not impede the working of the skilled workers, and an announcement information are recorded so as to respond to the advanced workers for preventing the trouble caused by the increased speed.

Similar to B03 and B04 the fifth image data B05 are those for which data for compilation are not built, and they are the recorded information which are recorded for the workers who work the working at a 140% working speed in case at recording, the speed considered to be said standard working speed is set to 100%.

The combined data of said image data B01 with said guidance information C01 are outputted to a terminal C01T, the combination of said image data B02 with said guidance information C02 is outputted to a terminal C02T, the combined data of said image data B03 with said guidance information C03 are outputted to a terminal C03T, the combined data of said image data B04 with said guidance information C04 are outputted to a terminal C04T, and the combined data of said image data B05 with said guidance information C05 are outputted to a terminal C05T. Then, these terminals C01T to C05T are selected for any one by a selector portion S01. The selected image and the audio data are transmitted through wireless LAN (local area network). Then, said sound is transmitted to the earphone E01 of the worker “E”, the image data is wireless transmitted to a display “A” to be the display means so as to be screened out, and further it is possible to blink an optical indication means F01 corresponding to the wireless LAN placed in an optional location based on an auxiliary indication signal.

The selector portion S01 is switched based on a signal sent from a detection means “D”. The information from the utilizer is inputted into the detection means “D”. For example, the wrist of the utilizer is mounted with a watch type wireless tag detection means E02 thereby to detect the condition of a wireless tag E03 (wireless tag which senses the state which passes or comes close without consciousness—hereinafter called unconscious transfer tag which is provided in the working space), and a wireless tag E04 (tag that conveys the worker's will and consciousness as well as the condition of the working environment—hereafter called the conscious transfer tag), and the detected result is sent to a wireless receiving section D01 equipped in the detection means so as to be delivered to the detection means “D”. The information received by the wireless receiving section D01 is inputted into a judgment section D02. Said judgment section D02 is connected in such a way that the data from the data base section D03 where the judgment reference is stored may be referenced to. As a result, the switching operation of the selector section S01 is instructed via an instruction or command signal transmission circuit D04.

The system for guiding and teaching the working condition, which is constituted as above, is such that the levels of the working procedure are exemplified in the level setting of three stages: “for beginners,” “standard” and “skillfully speedy,” and preferably, as stated later, a level setting in nine stages is possible.

Then, the operational condition of the system constituted as above will be described with reference to the flowchart of FIG. 3.

[G01] is initiation.

[G02] is to read the ID number by a previously prepared reader.

By referring to the read ID number and a data base [G05A] for working recording the final level of the working is deduced. Then, the data at that the final level was recorded is deducted. If said data is within one week, said final level is adopted as it is, but if said data is more than one week and less than two weeks the level is lowered by one stage. If the date is more than three weeks the level is lowered by two stages.

[G03] is to select the image data corresponded to the level determined in [G02] and guiding information corresponded to the determined level. For example, the image data B01 and the guiding information C01 are selected by the selector section, when the selected image data is presented on the display so as to be seen by the worker. Further, the selected guiding information is fed to the earphone E01 and blinks the light indication means F01 as desired thereby to instruct to bring the article placed in a remote location. The details of these operations are correspondingly described in FIG. 1.

[G04] is a step for judging whether the worker can follow the working correspondingly to the information instructed in [G03]. By referring to the detection information obtained such that the wireless tag E03 (unconscious transfer type tag) provided in the working space and the wireless tag group D04 (conscious transfer type tag) mounted like apron to the worker are brought close to the detection means E02 of the watch-type wireless tag fixed to the worker, and by the data base section D03 of storing a reference for judging based on said detected information, any one of the following operations is determined:
whether a new level is established in step [G03],
whether step [G04A] is tentatively stopped,
whether the system for guiding and teaching the working procedure is amended by the controller in step [G04B], and
whether the system for guiding and reaching the working procedure is thoroughly stopped in step [G04C].

Hereinafter the material instructions content associated with the data base section D03 will be described.

As described above, the watch type wireless detection means E02 can obtain, in conjunction with the worker's movement, the tag information (unconscious transfer type tag) provided in the working space or neighbouring with the working space. For example, the following tags [T001] to [T010] can be mentioned.

[T001] Working cycle starting tag

[T002] Motion element (1) pass tag

[T003] Motion element (2) pass tag

[T004] Motion element (3) pass tag

[T005] Motion element (4) pass tag

[T006] Motion element (5) pass tag

[T007] Motion element (6) pass tag

[T008] Motion element (7) pass tag

[T009] Motion element terminal tag

[T010] Inferior motion pass tag

In the case of normality said tags are repeatedly detected by the detection means E02 within a certain time range and regularly in sequence.

On the other hand, in case the unconscious transfer type tags react in different sequence there appears a procedure-mistaken doubt strongly, and then an instruction for tentatively stopping the system is emitted at a timing as soon as possible.

If a tag which is not to pass in the present working enters, it is recognized as an inferior motion pass tag thereby issuing an instructions for tentatively stopping the system at the most speedy timing as above.

In the case of normality, the time from the working cycle starting tag to the working cycle finishing tag is watched, and at the timing the image data corresponding to said level and the corresponding guiding information are regenerated at a speed corresponding to said level. Further, if the passing of said tag is delayed beyond allowance, the guiding information corresponding to the image data is rendered for delay (even in case the passing of the tag became faster at a timing beyond allowance it is possible to proceed with the guidance information corresponding to the image data).

The state in which the timing of said passing tag is delayed beyond allowance, is recorded in the database [G05A] for working recordal, and in case the timing is delayed by predicted number (for example four times), the working is initiated by lowering the level by one stage from the initiation of the following working cycle. Similarly, in the state where the timing has proceeded by predicted number the level is raised by one stage from the next working cycle. Moreover, in the state where both delayed information and advanced information do not generate, even in case the cycle is normal by four workings, it is judged that the worker is working with composure whereby an establishment is made to raise the level by one stage from the start of the next working cycle (said establishment need not be necessarily made, and it may be all right to apply it only to the worker who wishes to obtain a higher evaluation).

These conditions are set based on the database section D03 where the judging standard is stored.

In said database section D03 the judgment standard can be set in response to more complicated working. For example, in case in addition to the working for one cycle in said embodiment, a working for additional one cycle is constituted in the state of series on a time axis, the two workings will not be necessarily improved on the same level. In such case, it is possible to select either of the system of establishing the level for individual working cycle and the system of establishing the level by synthesizing the two cycles.

In case the delay and advance of the timing of said pass tag (unconscious transfer type tag) has not fixed tendency and advances or delays in disorder, in said database section D03 the unstable state is watched and following its finding it is judged to issue a signal of calling the controller without stopping the working. Further, the controller who received said signal observes the working condition at a quick timing and is required to find an improving point of the working, and preferably said improving point is recorded in the database [G05A] for working recordal. As necessary, the working image and guiding information for which the problems have been solved are re-prepared. Moreover, if the working becomes an unstable speed caused by the worker only, it will be desirable that the controller transfers to the working for caring the health of the worker.

In addition, the judgment criterion for grasping said unstable state is recorded in the database section D03, but preferably it is adapted such that after the improvement of said unstable element it is fed back whether said recorded judgment criterion was correct or not whereby the suitabilization of said judgment criterion can be repaired any time. Then, it is possible that the fall into the unstable state is recorded even in the database [G05A] for working recordal, and it is sought to the controller to gurantee to the lowered efficiency of the working, which is caused in the unstable state, and to prevent the working evaluation from lowering, according to the worker's desire.

The above is the instruction content in which the information of the tag (unconscious transfer type tag) provided near the working space can be instructed by the information obtained through the watch-type wireless tag detection means E02.

Then, the possible instruction by the detected information of the conscious transfer type tag will be described hereunder, said detected information being obtained by the proximity of the wireless tag group E04 mounted like apron to the worker with the watch type wireless tag detection means E02 mounted to the worker.

First of all, even if the wireless tag group E04 is installed too close the individual wireless tags cannot be recognized. Therefore, by keeping away the distance previously determined because of the relation between the wireless tag and the detection means, the tags are dispersed like apron. For instance, 13 wireless tags are provided as described below, and the descriptive matter for possessing a meaning for each of them is described in the apron.

Further, the worker can issue instruction only by coming close to the wireless tag group E04. This is excellent in that instruction can be issued without touching from the sanitary viewpoint and in even in the promptness capable of sending instruction without leaving the hands from the tool. Furthermore, in the selected information the confirmation signal is fed back acoustically by the earphone E01 so as to prevent instruction error. Further, the matters described on the apron surface are as follows.

[TO11] Temporary stopping (for resting)

[T012] Temporary stopping (due to system inconvenience)

[T013] Temporary stopping (due to material shortage)

[T014] Complete stopping (due to finished working)

[T015] Complete stopping (due to working change)

[T016] Complete stopping (due to the instruction by controller)

[T017] Complete stopping (for other reasoning)

[T018] Controller is called without stopping

[T019] Two stage level-down is wanted

[T020] One stage level-down is wanted

[T021] Status quo is wanted

[T022] One stage level-up is wanted

[T023] Two stage level-up is wanted

As in the above descriptive contents, the above matters [T011] to [T018] are to be transmitted in the working problems such as rest of the worker, stop of working or calling of the controller, through the apron type conscious transfer type tags. Said motions are as in the descriptive contents, but in the case of repeating the operation of the same button so frequently an establishment is possible so as not to cause a reaction.

Furthermore, the matters [T019] to [T023] correspond to the buttons desiring the matters related to the working speed. Even the motions corresponding to said buttons are as in the descriptive content, but similarly in case the same button is frequently pressed an establishment of dulling the reaction is possible.

For example, even if the same button is pressed within five minutes it is possible to set the system not to output a signal.

[G05] is a step where the temporary stopping and the correction of the system by the controller are finished and the working is re-started, at the same time as the re-starting of the working the process until the re-starting is recorded in the database [G05A] for working recordal.

[G06] is a step in which in response to the state reached the punctuation of the repeated working it is determined whether the worker is to keep the same working level even in the following repeating, to level up, to level down or to cease the working by stopping the repeated working. Even this instruction information is recorded in the database [G05A] for working recordal.

FIG. 4 shows another embodiment where nine stage levels can be established for the worker. Further, the present system is constructed such that for each level the color and the light quantity of light emission are set, and in addition to the working level currently set for the worker, the progressing condition of the working corresponding to the working level of eight stages may be virtually referenced to. Moreover, said embodiment is the one which is incorporated with a repeating training function in the instruction range capable of repeatedly training for individual motion element or for instructed plural motion elements.

FIG. 4 shows a case of a worker having a speed which is considered to be normal (standard) in particular. As the definition of rank there are set in nine stage levels from workers under training up to the workers having the maximum speed, and said workers correspond to the level to be “normal (standard)” i.e. the intermediate level of the fifth stage from the lower level and also the fifth stage even from the upper level. As described in line 5 from the upper right in the Table, the center value of the rating is described. Though the standard level describes 100, the unit is percentage. Then, when the standard level is set to 100%, for example, the level at the right end described to be the maximum speed is described as 180%. In case the standard working speed is 100% it is possible to assume that the maximum speed realizable by the working of this kind is 180%. The reasonability of this magnification can be endorsed from the study for determining many standard workings. In addition, as the descriptive method of magnification there can be mentioned a method where the magnification is displayed based on 1 as the standard, ant it is free what display is selected.

To draw the attention to the column “Time per cycle of the current working cycle,” 10 minutes are described and the description in order rank is kept blank. However, in the column lower by one column thereof, in the item “Time per cycle of the working steps, which is presumed when the level has changed,” the presuming time is described in the columns other than the normal rank. By observing said presuming time the worker can presumably observe to what extent rank it is possible to do the working fast. Further, in the presumption where the current working is at the maximum speed the system is set such that the working is finished within 5 minutes and 33 seconds, but in case it is impossible the error is caused by presumption of the controller, and it is a mistake to establish that the person who is currently working is working based on the evaluation called standard. Further, it results in that if the person currently working does not go up in rank the evaluation is not proper. In this embodiment the talking is progressed on the assumption that a correct rank is established.

In FIG. 4, in the farther lower side the production condition per day and the production condition per week are described in various ways.

Further, in the right side of the descriptive column of the production condition the display section (A) for imaging is recorded, and the outer frame of said display section is thick and colored in separate ranks (levels). Accordingly, the workers at present are colored in the frame with “sky blue” having the standard meaning.

Furthermore, the working of the whole motion elements is repeated, and in FIG. 4 the items of the motion elements are all reversed.

In addition, if desired it is capable of lighting, near the worker, a lamp of 5 nt light quantity which expresses the standard working level.

FIG. 5 shows the case of the worker under training. This worker is different from the standard worker in FIG. 4 in that the standard worker performs the whole working steps whereas only the three motion elements from the motion elements (1) to the motion element (3) are repeated. Said reversion is achieved, for example, with the instruction by using mouse.

Further, the outer frame of the display section is grey showing the level under training, and it is adapted such that by just seeing the display from a remote place it is understood that the current worker is under training.

It is described in the item “Time per cycle of the current working steps” that it take 50 minutes for the worker under training to finish the working for one cycle. In the column lower than that there is described, being simulated, the time per cycle which is assumed when said worker did the same working by leveling it up. For example, if two ranks are raised to reach the level “delayed” it is seen that the steps which currently takes 50 minutes can be finished in about 16 minutes, and it is possible to make effort for training consciously while seeing the presuming speed.

In addition, it is possible to light, near the worker, a lamp of 1 nt light quantity which expresses the standard working, if desired. Moreover, if the wavelength of the lamp could be changed for every group, the working quantity per group (for individual unit if desired) becomes clear by measuring the light quantity of an optional wavelength or the accumulation of said light quantity.

The wireless tag E03 need not be necessarily wireless tag. For example it can be constituted by a light source having a high directivity and a light-receiving element which continuously receives light beam from said light source, and the light received by the light-receiving element is interrupted in that the light source is interrupted by the arm or hand of the worker, and alteration is possible in that by the fact that the light was interrupted the worker detects that the resistance has passed the environment thereof.

In addition, said wireless tag group E04 can be constituted such that a great number of simplest button switches are provided and these switches are connected to the detection means via cable.

Further, as shown in FIG. 1 and FIG. 2 the embodiment 1 was explained being expressed like a steleoscopical structure, but the image data, the guidance information, the switching terminals, the selector section, the instruction signal transmission circuit, etc. can be replaced as the memories and programs for computer.

### INDUSTRIAL FIELD OF THE INVENTION

As described above in detail, according to the invention there is provided a system capable of carrying out even a rating training, in which relative to various working spots the working procedure as established in advance is guided and taught, and by the continuous use the working procedure is guided and taught in such a manner that the mastery and working speed of the utilizer may become automatically suitable, and in which the level of the mastery can be automatically evaluated, then while an unknown worker sees the working speed he/she makes a tentative establishment as to what extent the speed is relative to the standard working speed, and whether the tentatively established level is reasonable or not is judged.

Said various working spots are not limited to the assembling working of products but applied to all the workings which are required for flow of papers on desks and working procedures such as working procedure carried out on a display in computer working, working procedure of cooking, working procedure in medical treatment, working procedure of handling dangerous things, and working procedure for study.

### BRIEF DESCRIPTION OF THE DRAWINGS

FIG. 1 is a perspective view showing stereoscopically the working conditions of the system of the invention;

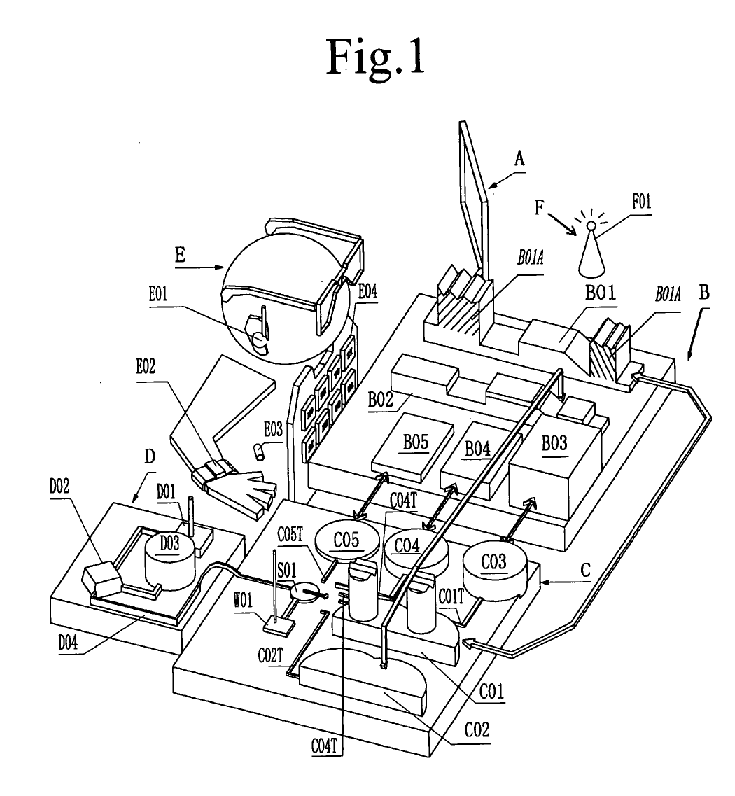

FIG. 2 is a perspective view which stereoscopically shows the working conditions of the system of the invention similarly to FIG. 1, in which the location of visual point is drawn being changed;

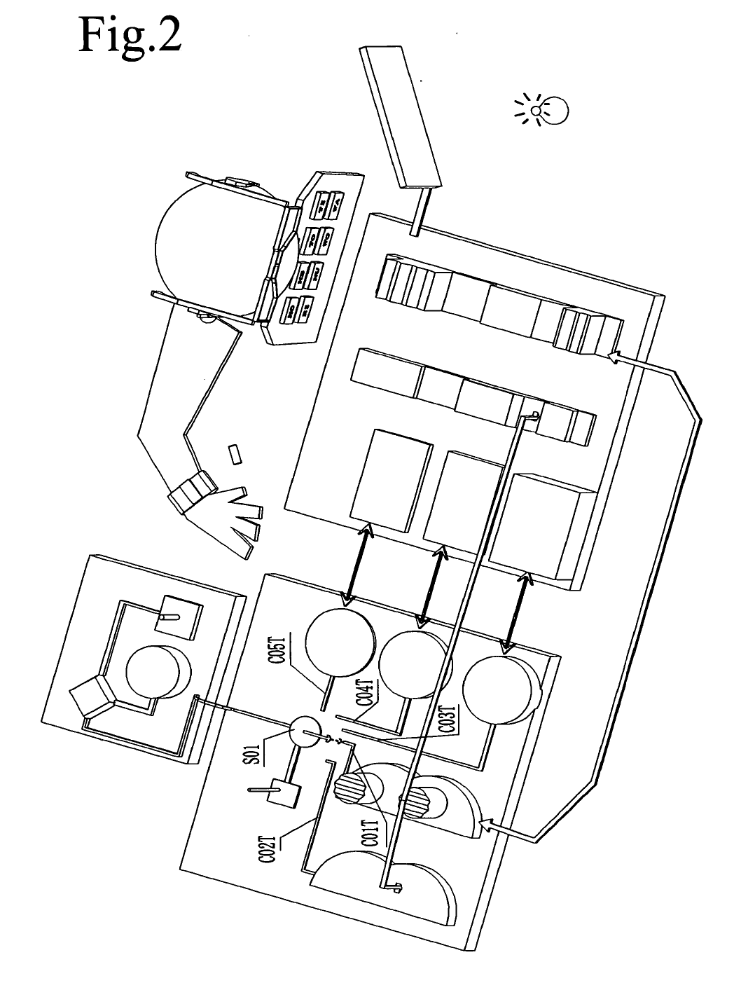

FIG. 3 is a flowchart;

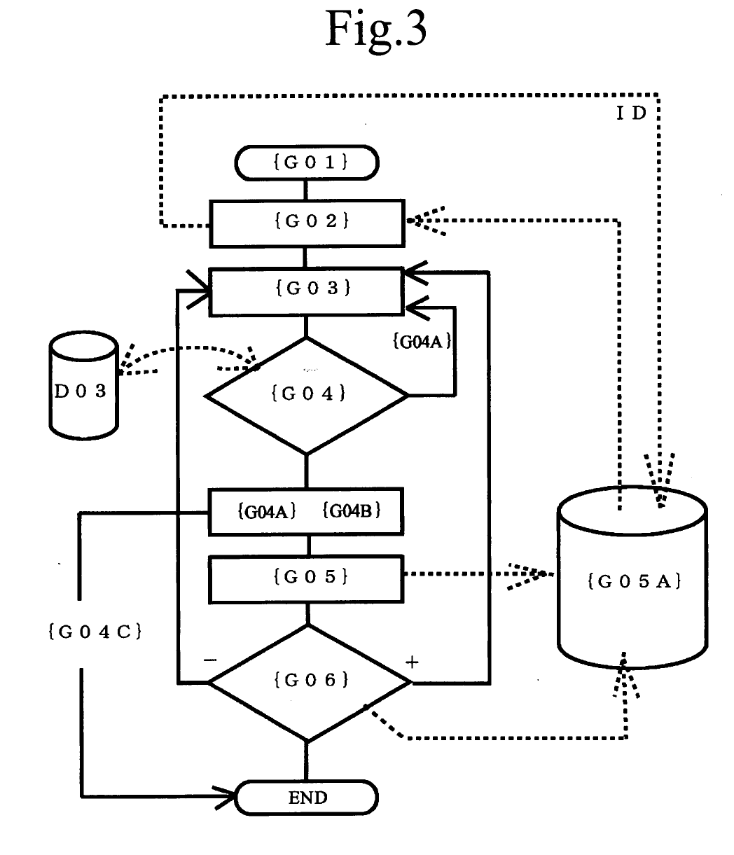

FIG. 4 shows images screened on the display in the embodiment where the worker can be established in nine stage levels, showing in particular the state utilized by the standard worker; and

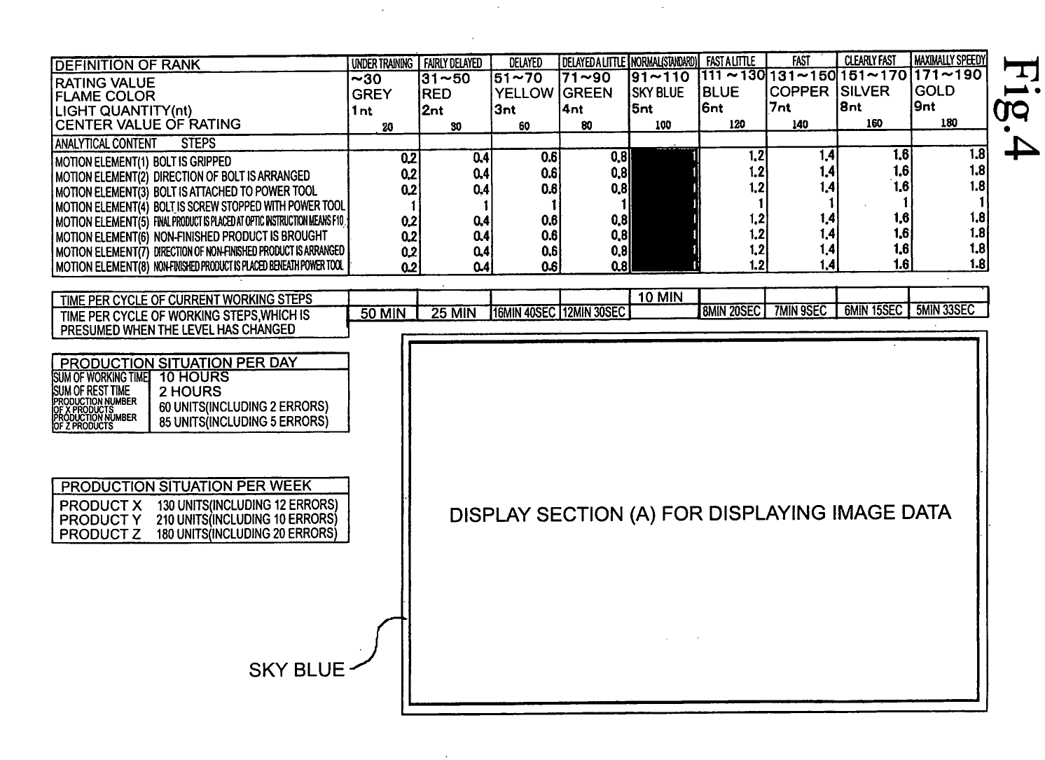

FIG. 5 shows images screened on the display in the embodiment where the worker can be established in nine stage levels, showing in particular the state utilized by the beginner (under training).

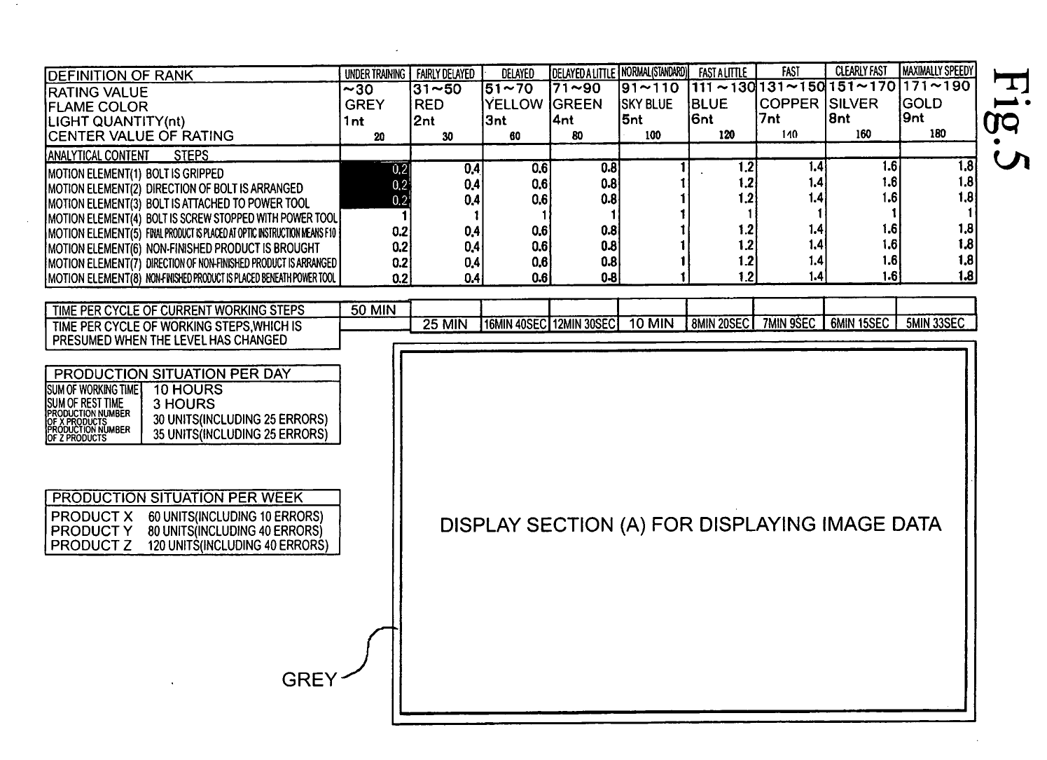

### DESCRIPTION OF REFERENCES

A: Display to be display means
B: Image data
C: Guiding information
D: Detection means
E: Worker
F: Light indication means
B01: Image data
B01A: Explanatory information
B03: Image data
B02: Image data
B04: Image data
B05: Image data
C01: Guiding information
C02: Guiding information
C03: Guiding information
C04: Guiding information
C05: Guiding information
C01T: Terminal
C02T: Terminal
C03T: Terminal
C04T: Terminal
C05T: Terminal
E01: Earphone
E02: Watch type wireless tag detection means
E03: Wireless tag
E04: Wireless tag
D01: Wireless signal-receiving section
D02: Judgment section
D03: Database section
D04: Instruction signal transmission circuit
S01: Selector section

1. A system for guiding and teaching a working procedure comprising:
display means in which the working procedure of a series of workings is stored as images of the working procedure, and the procedural images of the working are continuously displayed;
storage means of storing audio data which are associated with said working procedure of the series of workings and in which the guide information of the working procedure of at least a first level is recorded, and audio data of the guide information of the working procedure of a second level in which audio information less than the audio information is recorded in said first level;
detection means for detecting the working speed of a series of workings;
audio data selection means in which based on the working speed detected by said detection means the working procedure information to be outputted from among the plural working procedure information pieces stored in said storage means is selected; and
output means in which the audio data selected by said audio data selection means and the images displayed on said display means are outputted being associated.

2. A system for guiding and teaching a working procedure according to claim 1, wherein the images of said working procedure are analyzed for each motion element, a rating is established relative to the working speed for each said motion element, and in response to said working speed said rating is varied so that the difference between the working speed and the images of the working procedure is made adjustable.

3. A system for guiding and teaching a working procedure according to claim 1, wherein a pair of the audio data and image data are prepared for each level.

4. A system for guiding and teaching a working procedure according to claim 1, wherein the images of the working procedure are discriminated and displayed in part of the display means by the color or light quantity previously set for each level.

5. A system for guiding and teaching a working procedure according to claim 1, wherein by the detection means detected the working speed the level of the current working speed is displayed, a rating can be established relative to the working speed in response to other level, and the image processed by the rating in response to said other level can be referenced to.

6. A system for guiding and teaching a working procedure according to claim 1, wherein the detection result of said working speed or the fluctuation of the level is continuously recorded as computer data.

7. A system for guiding and teaching a working procedure according to claim 1, wherein in case the current level obtained by the detection means detected said working speed dose not reach the working speed of the level higher than said level but it exceeds the threshold previously set, the working procedure of the level higher than the current level is outputted.
